(19) United States
(12) Patent Application Publication
(10) Pub. No.: US 2014/0035814 A1
(43) Pub. Date: Feb. 6, 2014

(54) ADJUSTING SETTINGS OF A PRESENTATION SYSTEM

(71) Applicants: Diogo Strube de Lima, Porto Alegre Rio Grande do Sul (BR); Soma Sundaram Santhiveeran, Fremont, CA (US); Walter Flores Pereira, Porto Alegre (BR)

(72) Inventors: Diogo Strube de Lima, Porto Alegre Rio Grande do Sul (BR); Soma Sundaram Santhiveeran, Fremont, CA (US); Walter Flores Pereira, Porto Alegre (BR)

(21) Appl. No.: 13/563,644

(22) Filed: Jul. 31, 2012

(51) Int. Cl. G06F 3/033

(52) U.S. Cl. 345/158

(57) ABSTRACT

Techniques for adjusting settings of a presentation system are described in various implementations. A method that implements the techniques may include receiving, at a computer system and from an image capture device, an image that depicts a viewing area proximate to the presentation system. The method may also include processing the image, using the computer system, to determine whether a viewer is present in the viewing area. The method may also include, in response to determining that a viewer is present in the viewing area, processing the image, using the computer system, to determine an ambient lighting value associated with the viewing area and to determine a distance from the presentation system to the viewer. The method may also include adjusting a presentation setting of the presentation system based on the ambient lighting value and the distance.

### BACKGROUND

Advertising is a tool for marketing goods and services, attracting customer patronage, or otherwise communicating a message to an audience. Advertisements are typically presented through various types of media including, for example, television, radio, print, billboard (or other outdoor signage), Internet, digital signs, mobile device screens, and the like.

Digital signs, such as LED, LCD, plasma, and projected images, can be found in public and private environments, such as retail stores, corporate campuses, and other locations. The components of a typical digital signage installation may include one or more display screens, one or more media players, and a content management server. Sometimes two or more of these components may be combined into a single device, but typical installations generally include a separate display screen, media player, and content management server connected to the media player over a private network.

Regardless of how advertising media is presented, whether via a digital sign or other mechanisms, advertisements are typically presented with the intention of commanding the attention of the audience and to induce prospective customers to purchase the advertised goods or services, or otherwise be receptive to the message being conveyed. To achieve such goals, the message must generally be seen and/or heard to be effective.

### BRIEF DESCRIPTION OF THE DRAWINGS

FIG. 1 is a conceptual diagram of an example digital display system.

FIG. 2 is a block diagram of an example system for adjusting presentation settings of a presentation system.

FIG. 3 is a flow diagram of an example process for adjusting presentation settings of a presentation system.

### DETAILED DESCRIPTION

Presentation systems, such as digital signage installations, may include a number of input devices that are connected to the system for a variety of reasons, including to provide users with some level of interaction with the system. For example, in some cases, a presentation system may include an associated camera (e.g., a webcam) and/or a microphone, which may allow a user to interact with the system in a natural manner—e.g., by pointing to a desired option displayed by the system, or by speaking to the system to indicate a selection or a response. Certain presentation systems may also or alternatively include these and other types input devices for purposes other than to provide interactivity, such as for content analysis and/or selection by the system.

According to the techniques described here, the input devices associated with a particular presentation system, e.g., to provide a certain type of functionality, may also be used to detect various conditions around the presentation system. These detected conditions may then be used to affect a change in a presentation setting of the presentation system. In some cases, the changes in the presentation setting may improve the power consumption associated with the system, or may improve the user experience, or both. For example, the system may use an associated webcam to detect the ambient lighting conditions in an area surrounding the presentation system, and may also detect the presence of viewers and how for the viewers are from the system. Then, the system may change a setting on a display of the presentation system (e.g., brightness, contrast, sharpness, resolution, image size, font size, font style, color, or the like) based on the detected conditions. As another example, the system may use an associated microphone to detect ambient noise levels in the room, and may adjust a volume setting of the presentation system based on the detected noise level. These and other adjustments may be made based on inputs from devices that are already associated with the presentation system (e.g., for purposes of providing interactivity or for other purposes) such that additional sensors may not be necessary.

In an example implementation of the techniques described here, a method for adjusting presentation settings of a presentation system may include receiving, at a computer system and from an image capture device, an image that depicts a viewing area proximate to the presentation system. The method may also include processing the image, using the computer system, to determine whether a viewer is present in the viewing area. The method may also include, in response to determining that a viewer is present in the viewing area, processing the image, using the computer system, to determine an ambient lighting value associated with the viewing area and to determine a distance from the presentation system to the viewer. The method may also include adjusting a presentation setting of the presentation system based on the ambient lighting value and the distance.

In some cases, the techniques described here may provide improved end-user engagement by dynamically adjusting presentation parameters in response to changing conditions around the presentation system. In addition, the techniques may improve the power profile of the presentation system by reducing power consumption when less power can be used to achieve a desired effect, or by placing all or certain portions of the presentation system into a power-saving or sleep mode when viewers are not present. These and other possible benefits and advantages will be apparent from the figures and from the description that follows.

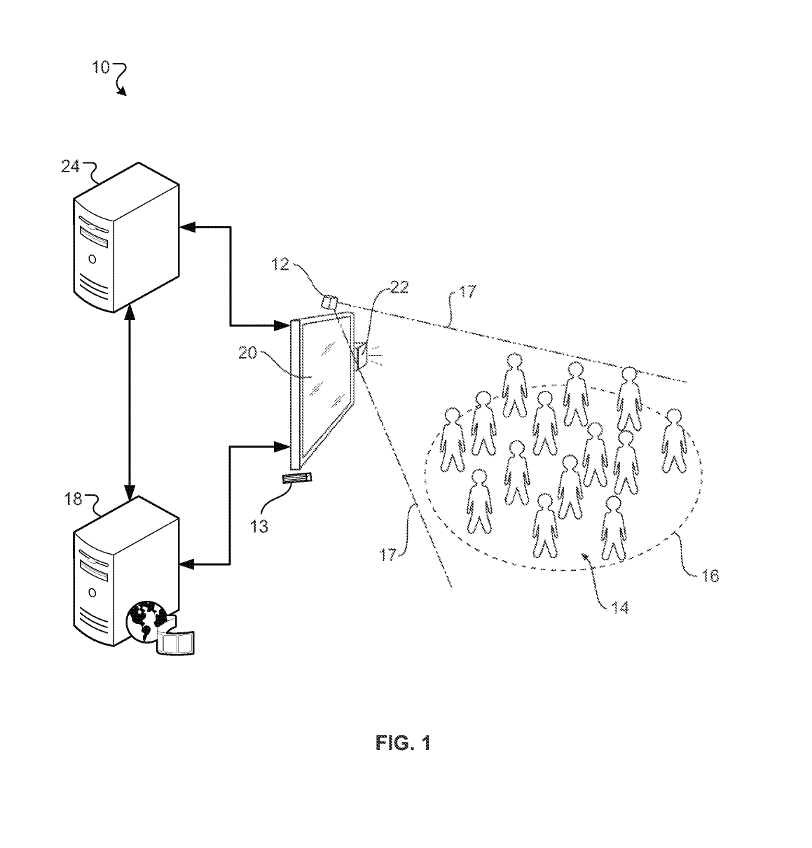

FIG. 1 is a conceptual diagram of an example digital display system 10. The digital display system 10, which may be representative of a digital signage installation, is one example of a presentation system as described herein. The example digital display system 10 includes at least one imaging device 12 (e.g., a camera) pointed at an audience 14 that is located in a viewing area. The viewing area is indicated here by a dotted line 16 that represents at least a portion of the field of view of the imaging device 12. Digital display system 10 also includes a content computer 18 and a presentation computer 24, either or both of which may be communicatively coupled to the imaging device 12. The content computer 18 may generally be configured to identify content to be presented to users of the digital display system 10, and the presentation computer 24 may generally be configured to control the presentation of such content.

Imaging device 12 may be configured to capture video images (i.e. a series of sequential video frames) at a desired frame rate, or to take still images, or both. The imaging device 12 may be a still camera, a video camera, or other appropriate type of device that is capable of capturing images. One example of a relatively inexpensive imaging device 12 is a webcam.

Imaging device 12 may be positioned near a changeable display device 20, such as a CRT, LCD screen, plasma display, LED display, display wall, projection display (front or rear projection), or any other appropriate type of display device. For example, in a digital signage application, the display device 20 can be a small or large size public display, and can be a single display, or multiple individual displays that are combined together to provide a single composite image in a tiled display. The display may also include one or more projected images that can be tiled together, combined, or superimposed in various ways to create a display. In some implementations, imaging device 12 may be integrated with display device 20.

Also positioned near the changeable display device 20 is an audio capture device 13, such as a microphone. In some implementations, the audio capture device 13 may be integrated with display device 20. The audio capture device 13 may be positioned in such a manner that it captures audible signals that are associated with viewing area 16—e.g., voices of users standing in or near viewing area 16, ambient noises that are present in or around viewing area 16, and the like. An audio output device, such as an audio speaker 22, may also be positioned near the display device 20, or integrated with the display device, to broadcast audio content along with the visual content provided on the display.

Presentation computer 24 is communicatively coupled to the display device 20 and/or the audio speaker 22 to control the desired video and/or audio for presentation. The content computer 18 may be communicatively coupled to the presentation computer 24, which may allow feedback and analysis from the content computer 18 to be used by the presentation computer 24. The content computer 18 and/or the presentation computer 24 may also provide feedback to a video camera controller (not shown) that may issue appropriate commands to the imaging device 12 for changing the focus, zoom, field of view, and/or physical orientation of the device (e.g. pan, tilt, roll), if the mechanisms to do so are implemented in the imaging device 12.

Presentation computer 24 may include image analysis functionality, and may be configured to analyze visual images taken by the imaging device 12. The term “computer” as used here should be considered broadly as referring to a personal computer, a portable computer, an embedded computer, a content server, a network PC, a personal digital assistant (PDA), a smartphone, a cellular telephone, or any other appropriate computing device that is capable of performing the functions described here. For example, the techniques described here may be performed using a tablet or another type of mobile computing device.

In some implementations, a single computer may be used to control both the imaging device 12 and the display device 20. For example, the single computer may be configured to handle all functions of video image analysis, content selection, and control of the imaging device, as well as controlling output to the display. In other implementations, the functionality described here may be implemented by different or additional components, or the components may be connected in a different manner than is shown. Additionally, the digital display system 10 can be a network, a part of a network, or can be interconnected to a network. The network can be a local area network (LAN), or any other appropriate type of computer network, including a web of interconnected computers and computer networks, such as the Internet.

Presentation computer 24 can be any appropriate type of computing device, such as a device that includes a processing unit, a system memory, and a system bus that couples the processing unit to the various components of the computing device. The processing unit may include one or more processors, each of which may be in the form of any one of various commercially available processors. Generally, the processors may receive instructions and data from a read-only memory and/or a random access memory. The computing device may also include a hard drive, a floppy drive, and/or an optical drive (e.g., CD-ROM, DVD-ROM, or the like), which may be connected to the system bus by respective interfaces. The hard drive, floppy drive, and/or optical drive may access respective non-transitory computer-readable media that provide non-volatile or persistent storage for data, data structures, and computer-executable instructions to perform portions of the functionality described here. Other computer-readable storage devices (e.g., magnetic tape drives, flash memory devices, digital versatile disks, or the like) may also be used with the presentation computer 24.

The imaging device 12 may be oriented toward an audience 14 of individual people, who are gathered in a viewing area, designated by dotted line 16. While the viewing area is shown as having a definite outline with a particular shape, this is intended to represent that there is some appropriate area in which an audience can be viewed. The viewing area can be of a variety of shapes, and can comprise the entirety of the field of view 17 of the imaging device, or some portion of the field of view. For example, some individuals can be near the viewing area and perhaps even within the field of view of the imaging device, and yet not be within the viewing area that will be analyzed by the presentation computer 24.

In operation, the imaging device 12 captures an image of the viewing area, which may involve capturing a single snapshot or a series of frames (e.g., in a video). Imaging device 12 may capture a view of the entire field of view, or a portion of the field of view (e.g. a physical region, black/white vs. color, etc). Additionally, it should be understood that additional imaging devices (not shown) can also be used, e.g., simultaneously, to capture images for processing. The image (or images) of the viewing area may then be transmitted to the presentation computer 24 for processing.

Presentation computer 24 may receive the image or images (e.g., of the viewing area from imaging device 12 and/or one or more other views), and may process the image(s) to determine whether one or more individuals are present in the viewing area. Presentation computer 24 may use any appropriate face or object detection methodology to identify individuals captured in the image. If no users are present in the viewing area, then presentation computer 24 may put all or portions of the system into a power-saving or sleep mode, e.g., to save power when there are not any viewers in a position to observe the content as presented. In some implementations, a power-saving mode may include, for example, dimming the display or turning off the display, adjusting the volume of the speakers or turning off the speakers, reducing clock speeds of the content computer and/or presentation computer, reducing capture rates and/or processing rates associated with the captured audio or video, or the like. The power-saving mode may also include other appropriate power saying features or combinations of power saving features, and may be configurable by an administrator, e.g., based on an amount of time that users have been absent from the viewing area, a time of day or day of the week, or other appropriate parameters or combinations of parameters.

If a viewer is present in the viewing area, presentation computer 24 may determine the distance the viewer is from the display, e.g., based on an analysis of the captured image. For example, presentation computer 24 may implement facial detection techniques to detect faces included in an image, and may determine boundaries of a detected face, such as by generating a bounding rectangle (or other appropriate boundary) that approximates the dimensions of the detected face. Based on the size of the bounding rectangle (e.g., a diagonal measurement of the rectangle or other appropriate measurement), presentation computer 24 may estimate how far the viewer is from the imaging device 12, which may then be correlated with the distance between the viewer and the display device 20. Such distance estimates may be based on statistical models of typical facial proportions and how the relative size of the facial proportions varies with distance from the imaging device. In some cases, other mechanisms for detecting distance, such as depth-detecting cameras or other types of depth sensors, may be included to determine the distance of a viewer. If more than one viewer is present, the system may determine which distance (or distances) to use based on the particular implementation. For example, in some implementations the furthest distance may be used, while in other implementations the nearest distance may be used, and in still other implementations an average or other appropriate combination of distances may be used.

Presentation computer 24 may also determine an ambient lighting value associated with the viewing area based on an analysis of the captured image. For example, presentation computer 24 may process a predefined marker within the field of view of imaging device 12 to determine the ambient lighting level of the viewing area. The ambient lighting level may change over the course of a day (e.g., as shadows are cast from moving light sources, or as other local conditions change), so presentation computer 24 may continuously or periodically monitor the ambient lighting conditions in the viewing area.

Based on the determined distance of the viewers and the ambient lighting value, presentation computer 24 may adjust one or more presentation settings of the presentation system. For example, when users are further away and/or when ambient lighting is high, the brightness setting of the display may be increased. Conversely, when users are closer to the display and/or when ambient lighting in the viewing area is low, the brightness setting may be decreased. Other appropriate display settings, such as contrast, sharpness, resolution, image size, font size, font style, color, and the like, may also be adjusted in a similar manner—e.g., based on the distance of viewers and/or ambient lighting conditions determined from an analysis of the images provided by imaging device 12. In some implementations, the ambient lighting value may be compared to a baseline or calibrated lighting level to determine whether the current ambient lighting level is high or low. In other implementations, the current ambient lighting value may be compared to the previous detected ambient lighting value, and the settings of the display device may be adjusted upwards or downwards accordingly. In short, the presentation computer 24 may dynamically (e.g., continuously or periodically) adjust the settings of the display device to match the current conditions in the viewing area.

Input from the audio capture device 13 may be analyzed and used in a similar manner. For example, presentation computer 24 may receive audio input, e.g., from a microphone pointed towards the viewing area, and may process the audio input to determine an ambient noise value associated with the viewing area. Based on the ambient noise value and/or the other detected conditions (e.g., distance from the system to the users), presentation computer 24 may adjust an audio setting of the system. For example, when users are further away and/or when ambient noise is high, the volume setting associated with speaker 22 may be increased. Conversely, when users are closer to the system and/or when ambient noise in the viewing area is low, the volume setting may be decreased. In some implementations, the ambient noise value may be compared to a baseline or calibrated noise level to determine whether the current ambient noise level is high or low. In other implementations, the current ambient noise value may be compared to the previous detected ambient noise value, and the volume settings may be adjusted upwards or downwards accordingly. Once again, the presentation computer 24 may dynamically adjust the volume settings, e.g., continuously or periodically, to address the current conditions in the viewing area.

Because presentation systems, such as digital display system 10, often include input devices such as cameras and/or microphones for a variety of other purposes, such systems may not require separate or specialized sensors to provide inputs for dynamically adjusting the presentation settings of the system. In addition, the presentation systems may not require user intervention to maintain the presentation settings at optimal levels, even as conditions around the presentation systems change.

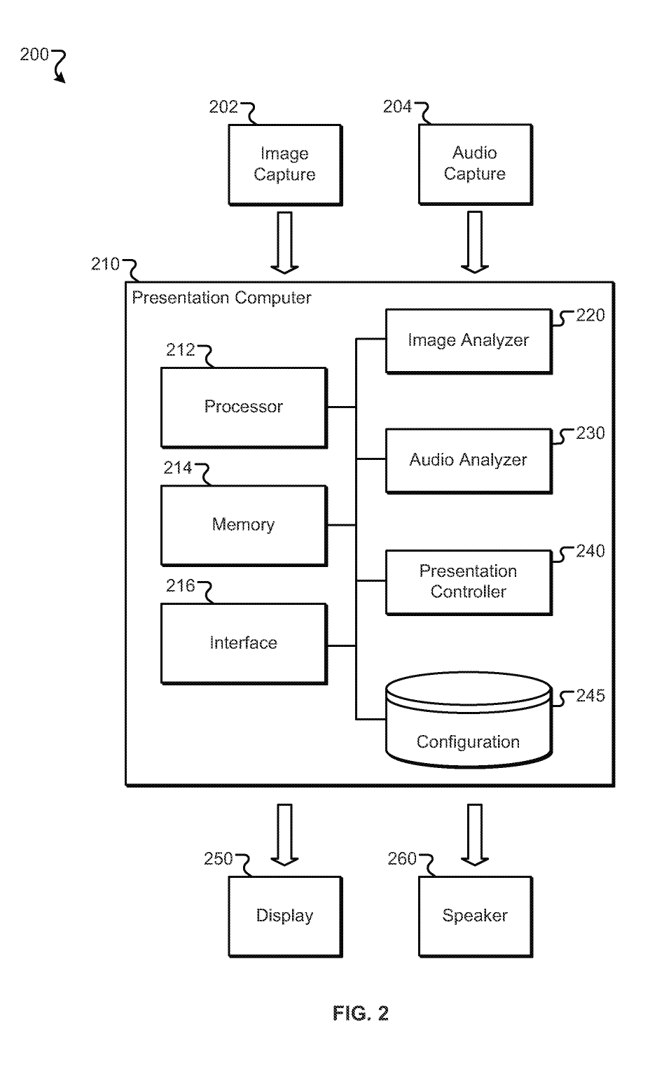

FIG. 2 is a block diagram of an example system 200 for adjusting presentation settings of a presentation system. System 200 includes an image capture device 202 and an audio capture device 204, both of which are communicatively coupled to presentation computer 210. In some implementations, the presentation computer 210 may also be communicatively coupled to other input devices (not shown). The presentation computer 210 may be configured to adjust presentation settings of the presentation system based on one or more inputs received from the input devices. For example, the presentation computer 210 may adjust one or more presentation settings of communicatively coupled output devices, such as a display device 250 and/or a speaker device 260, based on an analysis of the inputs. In some implementations, the presentation computer 210 may also be configured to adjust presentation settings of other output devices (not shown).

Image capture device 202 may include, for example, a still or video camera, a webcam, or an application that provides an image of a viewing area to the presentation computer 210. As used here, an image is understood to include a snapshot, a frame or series of frames (e.g., one or more video frames), a video stream, or other appropriate type of image or set of images. In some implementations, multiple image capture devices or applications may be used to provide images to presentation computer 210 for analysis. For example, multiple cameras may be used to provide images that capture different angles of a specific location (e.g., multiple views of a viewing area in front of a display), or different locations that are of interest to the system 200 (e.g., views of a store entrance where the display is located, or the like).

Audio capture device 204 may include, for example, a microphone or an application that provides an audio input associated with a viewing area to the presentation computer 210. In some implementations, multiple audio capture devices or applications may be used to provide audio input to presentation computer 210 for analysis. For example, multiple microphones may be used to provide audio that captures different portions of the audible spectrum, or that captures audio inputs from multiple locations or perspectives.

Other input devices may also be configured to provide inputs to presentation computer 210 for analysis. Such inputs may include extrinsic attributes associated with the viewing area or other areas that are relevant to the system, including attributes such as time of day, date, holiday periods, a location of the presentation system, or the like. For example, a location attribute (children's section, women's section, men's section, main entryway, etc.) may specify the placement or location (e.g., geo-location) of the system 200, e.g., within a store or other space. Another example of an extrinsic attribute is an environmental parameter (e.g., temperature or weather conditions, etc.). In some implementations, the extrinsic attribute detector may include an environmental sensor and/or a service (e.g., a web service or cloud-based service) that provides environmental information including, e.g., local weather conditions or other environmental parameters, to presentation computer 210. Such extrinsic attributes may be used, e.g., for purposes of calibrating the system or as additional inputs to adjust the presentation settings of the system.

As shown, presentation computer 210 may include a processor 212, a memory 214, an interface 216, an image analyzer 220, an audio analyzer 230, a presentation controller 240, and a configuration repository 245. It should be understood that these components are shown for illustrative purposes only, and that in some cases, the functionality being described with respect to a particular component may be performed by one or more different or additional components. Similarly, it should be understood that portions or all of the functionality may be combined into fewer components than are shown.

Processor 212 may be configured to process instructions for execution by the presentation computer 210. The instructions may be stored on a non-transitory tangible computer-readable storage medium, such as in main memory 214, on a separate storage device (not shown), or on any other type of volatile or non-volatile memory that stores instructions to cause a programmable processor to perform the functionality described herein. Alternatively or additionally, presentation computer 210 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the functionality described herein. In some implementations, multiple processors may be used, as appropriate, along with multiple memories and/or different or similar types of memory.

Interface 216 may be used to issue and receive various signals or commands associated with presentation computer 210. Interface 216 may be implemented in hardware and/or software, and may be configured, for example, to receive various inputs from input devices 202 and/or 204 and to issue commands to output devices 250 and/or 260. Interface 216 may also provide a user interface for interaction with a user, such as a system administrator. For example, the user interface may provide an input that allows a system administrator to configure how various presentation settings are to be adjusted based on the detected conditions around the system.

Image analyzer 220 may execute on processor 212, and may be configured to process one or more images received from image capture device 202. For example image analyzer 220 may process an image of the viewing area to determine whether one or more individual are present in the viewing area. Image analyzer 220 may also process the image to determine the distance the viewer is from the display. Image analyzer 220 may use any appropriate face or object detection methodology to identify individuals captured in the image. In some cases, image analyzer 220 may implement facial detection techniques to detect faces included in an image, and may determine boundaries of a detected face, such as by generating a bounding rectangle (or other appropriate boundary) that approximates the dimensions of the detected face. Based on the size of the bounding rectangle (e.g., a diagonal measurement of the rectangle or other appropriate measurement), image analyzer 220 may estimate how far the viewer is from the image capture device 202, which may then be correlated with the distance between the viewer and the system.

Image analyzer 220 may also process the one or more images received from image capture device 202 to determine an ambient lighting value surrounding the system. In some cases, image analyzer 220 may process a predefined marker within the field of view of the image capture device 202 to determine the ambient lighting level of the viewing area. The ambient lighting level may change over the course of a day (e.g., as shadows are cast from moving light sources, or as other local conditions change), so presentation computer 210 may monitor the ambient lighting conditions in the viewing area over time, such as on a continuous or periodic basis.

Audio analyzer 230 may execute on processor 212, and may be configured to process one or more audio inputs received from audio capture device 204. For example audio analyzer 230 may process an audio input associated with the viewing area to determine an ambient noise value associated with the viewing area. The ambient noise level may change over the course of a day (e.g., as foot traffic around the system increases or decreases, or as other local conditions change), so presentation computer 210 may monitor the ambient noise conditions in the viewing area over time, such as on a continuous or periodic basis.

Presentation controller 240 may execute on processor 212, and may be configured to control one or more presentation settings based on the processing performed by image analyzer 220 and/or audio analyzer 230. For example, if image analyzer 220 determines that no users are present in the viewing area, then presentation controller 240 may initiate a power-saving mode for all or portions of the system, e.g., to save power when there are not any users present. In some implementations, a power-saving mode may include, for example, dimming the display or turning off the display, adjusting the volume of the speakers or turning off the speakers, reducing clock speeds of the content computer and/or presentation computer, reducing capture rates and/or processing rates associated with the captured audio or video, or the like. The power-saving mode may also include other appropriate power saving features or combinations of power saving features, and may be configurable by an administrator, e.g., based on an amount of time that users have been absent from the viewing area, a time of day or day of the week, or other appropriate parameters or combinations of parameters. Such configurations and configuration parameters may be stored in the configuration repository 245, which may be accessible by the presentation controller 240.

In some cases, presentation controller 240 may be configured to adjust a display setting associated with display device 250. For example, when users are further away and/or when ambient lighting is high, the brightness setting of the display may be increased. Conversely, when users are closer to the display and/or when ambient lighting in the viewing area is low, the brightness setting may be decreased. Contrast and other appropriate display settings may also be adjusted in a similar manner—e.g., based on the distance of viewers and ambient lighting conditions determined from an analysis of the images provided by image capture device 202. To affect the adjustment, presentation controller 240 may issue an appropriate command to display device 250, e.g., either directly or in another appropriate manner such as via interface 216.

In some cases presentation controller 240 may be configured to adjust an audio setting associated with speaker device 260. For example, when users are further away and/or when ambient noise is high, the volume setting may be increased. Conversely, when users are closer to the system and/or when ambient noise in the viewing area is low, the volume setting may be decreased. To affect the adjustment, presentation controller 240 may issue an appropriate command to speaker device 260, e.g., either directly or in another appropriate manner such as via interface 216.

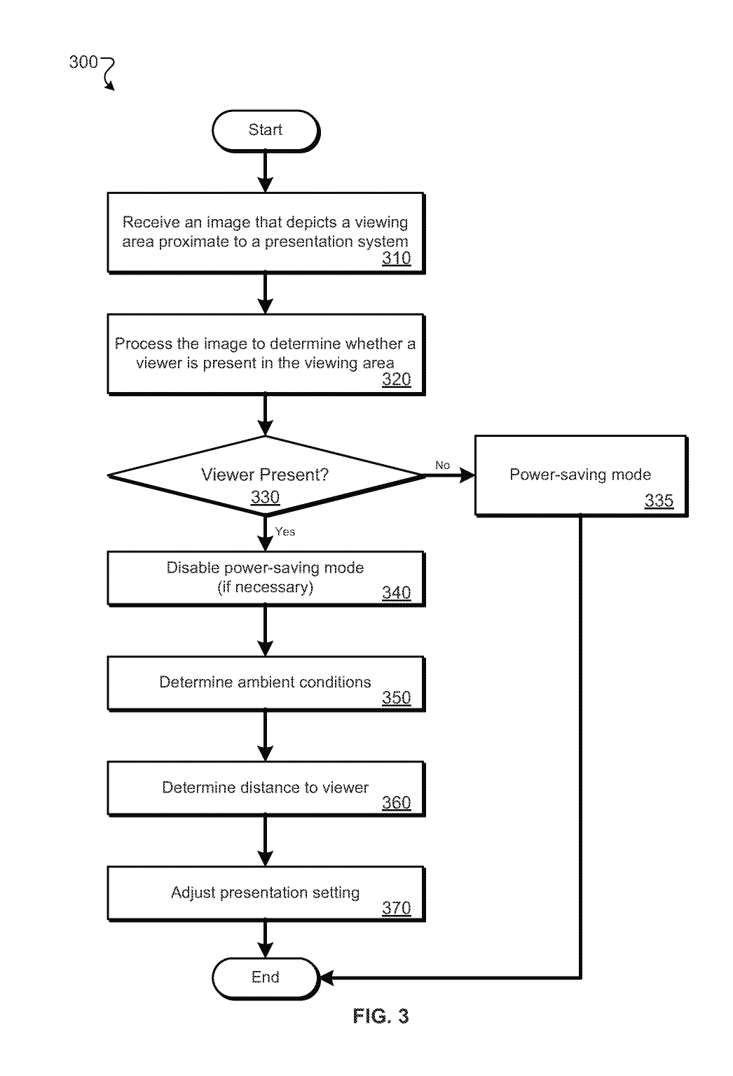

FIG. 3 is a flow diagram of an example process 300 for adjusting presentation settings of a presentation system. The process 300 may be performed, for example, by a presentation computer such as the presentation computer 24 illustrated in FIG. 1. For clarity of presentation, the description that follows uses the presentation computer 24 illustrated in FIG. 1 as the basis of an example for describing the process. However, it should be understood that another system, or combination of systems, may be used to perform the process or various portions of the process.

Process 300 begins at block 310 when a computer system, such as presentation computer 24, receives an image that depicts a viewing area proximate to a presentation system. The image may be received from an image capture device, such as a still camera, a video camera, a webcam, or other appropriate device positioned to capture one or more images of the viewing area.

At block 320, presentation computer 24 may process the received image to determine whether a viewer is present in the viewing area. For example, presentation computer 24 may analyze the image using any appropriate facial or object detection technologies to determine whether any objects shown in the image correspond to human individuals. If not, then a power-saving mode may be initiated at block 335. If so, then the power-saving mode may be disabled (if necessary) at block 340. In some cases, the power-saving mode may affect all or portions of the presentation system, such as reducing power to one or more of the display device, the speaker, the image capture device, the audio capture device, and/or the computer system. When an individual is detected in the viewing area after the power-saving mode has been initiated, presentation computer 24 may disable the power-saving mode by restoring power to the affected devices.

At block 350, if a user is present in the viewing area, the presentation computer 24 may process received inputs (e.g., an image and/or a sound input) to determine ambient conditions around the system. For example, presentation computer 24 may process the image depicting the viewing area proximate to the presentation system to determine an ambient lighting value associated with the viewing area. As another example, presentation computer 24 may also or alternatively process an audio input associated with the viewing area to determine an ambient noise value associated with the viewing area. At block 360, presentation computer 24 may also process the image depicting the user in the viewing area to determine a distance to the viewer.

At block 370, the presentation computer 24 may adjust a presentation setting of the presentation system, such as by adjusting a display setting of a display of the presentation system and/or by adjusting a volume setting of a speaker of the presentation system.

In various implementations, process 300 may execute periodically (e.g., every five minutes), continuously (e.g., in a continuous loop), or based on an execution command (e.g., from an administrator). In some implementations, when process 300 is configured to execute continuously, the processing cycles or the quantity of the inputs analyzed may be reduced while the system is operating in a power-saving mode. For example, the processor speed of the processor may be reduced, or the processor may process the images at a rate of five frames per second as opposed to thirty frames per second. These and other appropriate configurations are within the scope of the techniques described here.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A method for adjusting settings of a presentation system, the method comprising:
receiving, at a computer system and from an image capture device, an image that depicts a viewing area proximate to the presentation system;
processing the image, using the computer system, to determine whether a viewer is present in the viewing area;
in response to determining that a viewer is present in the viewing area, processing the image, using the computer system, to determine an ambient lighting value associated with the viewing area and to determine a distance from the presentation system to the viewer; and
adjusting a presentation setting of the presentation system based on the ambient lighting value and the distance.

2. The method of claim 1, wherein adjusting the presentation setting comprises adjusting a display setting of a display of the presentation system.

3. The method of claim 2, wherein the display setting includes at least one of brightness and contrast.

4. The method of claim 1, further comprising receiving, at the computer system and from an audio capture device, an audio input associated with the viewing area, and processing the audio input, using the computer system, to determine an ambient noise value associated with the viewing area, wherein adjusting the presentation setting is further based on the ambient noise value.

5. The method of claim 5, wherein adjusting the presentation setting comprises adjusting a volume setting of a speaker of the presentation system.

6. The method of claim 1, further comprising, in response to determining that a viewer is not present in the viewing area, initiating a power-saving mode on a display of the presentation system.

7. The method of claim 1, further comprising, in response to determining that a viewer is not present in the viewing area, initiating a power-saving mode on the computer system.

8. A presentation system comprising:
a display device;
an image capture device that captures an image of a viewing area associated with the display device;
an image analyzer, executing on a processor, that processes the image to determine an ambient lighting value associated with the viewing area and a distance from the display device to a viewer who is present in the viewing area; and
a presentation controller, executing on a processor, that adjusts a presentation setting of the presentation system based on the ambient lighting value and the distance.

9. The presentation system of claim 8, wherein adjusting the presentation setting comprises adjusting a display setting of the display device.

10. The presentation system of claim 9, wherein the display setting includes at least one of brightness and contrast.

11. The presentation system of claim 8, further comprising an audio capture device that captures an audio input associated with the viewing area, and an audio analyzer, executing on a processor, that processes the audio input to determine an ambient noise value associated with the viewing area, wherein the presentation controller adjusts a different presentation setting of the presentation system based on the ambient noise value and the distance.

12. The presentation system of claim 11, wherein adjusting the different presentation setting comprises adjusting a volume setting of a speaker of the presentation system.

13. The presentation system of claim 8, wherein the presentation controller initiates a power-saving mode of the display in response to a determination that a viewer is not present in the viewing area.

14. The presentation system of claim 8, further comprising, wherein the presentation controller initiates a power-saving mode of the image analyzer in response to a determination that a viewer is not present in the viewing area.

15. A non-transitory computer-readable storage medium storing instructions that, when executed by a processor, cause the processor to:
receive an image that depicts a viewing area proximate to the presentation system;
process the image to determine whether a viewer is present in the viewing area;
in response to determining that a viewer is present in the viewing area, process the image to determine an ambient lighting value associated with the viewing area and to determine a distance from the presentation system to the viewer; and
cause a presentation setting of the presentation system to be adjusted based on the ambient lighting value and the distance.
